(19) United States
(12) Patent Application Publication
(10) Pub. No.: US 2014/0267946 A1
(43) Pub. Date: Sep. 18, 2014

(54) TOUCH MEMBER AND METHOD OF MANUFACTURING THE SAME

(71) Applicant: TECO NANOTECH CO., LTD., TAOYUAN COUNTY (TW)

(72) Inventors: DING-KUO DING, TAOYUAN COUNTY (TW); SHIOU-MING LIU, TAOYUAN COUNTY (TW); YAO-ZONG CHEN, TAOYUAN COUNTY (TW)

(73) Assignee: TECO NANOTECH CO., LTD., TAOYUAN COUNTY (TW)

(21) Appl. No.: 13/844,846

(22) Filed: Mar. 16, 2013

(51) Int. Cl. G02F 1/1333; G02B 27/22

(52) U.S. Cl. CPC G02F 1/13338; G02B 27/22
USPC 349/12; 264/105

(57) ABSTRACT

A method of manufacturing a touch member includes firstly providing a plate like substrate including a planar electrode area and a planar circuit area arranged on the surface thereof. Secondly the first plane is covered a first conductive material is coated on the electrode area to form a transparent electrode layer. The first conductive material is constituted of carbon nanotubes. Subsequently, a second conductive material is applied on the circuit area to form a circuit layer. The circuit layer is led from the electrode layer. Finally, the substrate is shaped to from a flexible or stereoscopic transparent electrode.

### BACKGROUND

1. Field of the Invention

The instant disclosure relates to an input device and method of manufacturing the same; in particular, to a touch member and method of manufacturing the same.

2. Description of Related Art

Touch panels are widely implemented in electronic devices as the user interface technology advances, for example, mobile phones, navigation systems, tablets, personal digital assistant (PDA), industrial control panel and the like. According to different transmitting media, touch member is generally categorized as resistive, capacitive, optical and sonic sensors. The resistive or capacitive sensors are commonly used in conventional touch devices. For capacitive sensors, when an object contacts the panel, the capacitance between the object and a conductive layer changes accordingly. A touch control processor undergoes calculation of electrical current variation and obtains the location of the contact spot.

Curved outline has been widely introduced to the electronic devices. However, touch members are restricted to flat panel due to technical issues. For instance, conventional conductive material such as indium tin oxide (ITO) is prone to break after bending. The electronic devices with non-flat morphology, for example, mouse, joystick and case of display device, require deformable touch members to provide a different input option.

### SUMMARY OF THE INVENTION

The object of the instant disclosure is to provide a method of manufacturing a deformable touch member and utilize a specialized transparent conductive material to enhance the flexibility. The method of manufacturing the deformable touch member includes steps of: firstly, a substrate is provided. The plate like substrate has at least one planar electrode area and at least one planar circuit area, which enclose the electrode area. A first conductive material, which is constituted of carbon nanotubes, is applied partially to the electrode area to form a transparent electrode layer. Subsequently, a second conductive material is applied to a portion of the circuit area to form a circuit layer, which electrically couples to the transparent electrode layer. Finally, the substrate is shaped to form deformable and stereoscopic transparent electrodes.

According to one exemplary embodiment of the instant disclosure, a touch member is provided, which includes a plate like substrate, stereoscopic transparent electrodes and a circuit layer. The substrate includes an electrode area and a circuit area. The stereoscopic transparent electrodes include transparent electrode layer formed on the electrode area. The transparent electrode layer is made of transparent conductive material constituted of carbon nanotubes. The circuit layer is formed on the circuit area and electrically couples to the transparent electrode layer.

In summary, the touch member is highly flexible in shape as well as chemically stable and the method of manufacturing the same provides a high yield rate and simplified fabrication process.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

FIG. 1 is a flow chart of a method of manufacturing a touch member in accordance with one embodiment of the instant disclosure;

FIGS. 1A and 2A are top views of a method of manufacturing a touch member according to FIG. 3;

FIG. 1B illustrates a cross-sectional view along a line A-A of FIG. 1A;

FIG. 2B illustrates a cross-sectional view along a line BB of FIG. 2A;

FIG. 3 illustrates a cross-sectional view of a touch member in accordance with an embodiment of the instant disclosure; and

FIG. 4 illustrates a top view of a touch member in accordance with another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

The instant disclosure provides a method of manufacturing a deformable or stereoscopic touch member.

Referring to FIGS. 1, 1A, 2A and 3. FIG. 1 shows a flow chart of the method. FIGS. 1A and 2A illustrate top views of the touch member of FIG. 3 in the fabrication process. FIG. 3 illustrates a cross-sectional view of the touch member 1a. The first embodiment of the instant disclosure includes the steps of:

Step S101: providing a plate like substrate 100 having at least one planar electrode area 110 and at least one planar circuit area 120 arranged on the surface 101 thereof.

Step S103: applying a first conductive material to a portion of the electrode area 110 to form a transparent electrode layer 200. The first conductive material is constituted of carbon nanotubes.

Step S105: partially applying a second conductive material to the circuit area 120 to form a circuit layer 300. The circuit layer 300 and transparent electrode layer 200 are electrically coupled.

Step S107: shaping the substrate 100 to form a deformable or stereoscopic transparent electrode 201.

The method of manufacturing the touch member is further described hereinafter. Please refer to FIGS. 1A and 1B. FIG. 1B illustrates a cross-sectional view along the line AA of FIG. 1A. Firstly, the plate like substrate 100 is provided. The substrate 100 includes at least one planar electrode area 110 and at least one planar circuit area 120 arranged on the surface 101 thereof. In the instant embodiment, the substrate 100 is a flat board including a top plane 102 and a bottom plane 103 opposing the top plane 102. The electrode and circuit areas 110, 120 are arranged on the top plane 102. Specifically, the electrode area 110 is surrounded by the circuit area 120. The substrate 100 can be a film or in different shapes yet the surface 101 is flat to accommodate the electrode layer 200 and the circuit layer 300.

The substrate 100 is made of insulating and visually transparent materials. In addition, the material is thermoplastic such as polyethylene terephthalate (PET), polycarbonate (PC), polymethyl methacrylate (PMMA), polypropylene (PP), polyethylene (PE), polyethersulfone (PES), polyimide (PI), epoxy and the like. In the instant embodiment, the bottom plane 103 may be the primary contact face and upon the contact of an object, electrostatic capacitance is generated between the transparent electrode 201 on the top plane 102 and the bottom plane 103. Additionally, the thickness of the substrate 100 ranges from 50 to 700 micrometers (μm) and the preferable thickness is 125 μm or 188 μm.

Please refer to FIGS. 2A and 2B. FIG. 2B illustrates a cross-sectional view of the touch member 1a along line BB of FIG. 2A. Subsequently, the first conductive material is coated onto the portion of the electrode area 110 to form a transparent electrode layer 200. The first conductive material is transparent and electrically conductive constituted of carbon nanotubes. Specifically, the first conductive material is constituted of carbon nanotubes, organic conductive paste and solvent. The organic conductive paste can be such as poly-3,4-ethylenedioxythiophene/Poly(styrenesulfonate) (PEDOT/PSS), and the solvent can be such as water, ethanol, iso-propyl alcohol (IPA), methyl alcohol and the combination thereof. In the instant embodiment, the solvent is the combination of water and IPA. The carbon nanotubes of the first conductive material may be intertwined or aligned while mutually attach to one another by van der Waals forces to form a network with micro-porous structure. Furthermore, the carbon nanotubes can be single-walled, double-walled, multi-walled and the combination thereof. The single-walled carbon nanotubes measure a diameter ranging from 0.5 to 50 nanometers (nm), the double-walled carbon nanotubes 1.0 to 50 nm, and the multi-walled carbon nanotubes 1.5 to 50 nm.

In the instant embodiment, the first conductive material is coated onto the electrode area 110 of the substrate 100 to form a transparent electrode layer 200. The transparent electrode layer 200 preferably measure 10 to 500 nm in thickness to allow desired transparency and resistance distribution. The preferred thickness provides higher accuracy and sharpness of the touch member 1a as well as the device using the same. It is worth mentioned that in the instant embodiment, the first conductive material only coats the portion of the electrode area 110 to form the patterned transparent electrode layer 200. The first conductive material may coat on the surface 101 by screen printing, sputtering, lithographing, inkjet printing or the like for the formation of the patterned transparent electrode layer 200. Conventional coating methods well known to those skilled in the art may be employed to form the electrode layer and the instant disclosure is not limited thereto.

Attention is now invited to FIG. 2A. The patterned transparent electrode layer 200 includes a plurality of conductive areas 210 separated by predetermined intervals. Specifically, each of the conductive areas 210 is substantially rectangle in similar size. The conductive areas 210 are parallel to each other and the immediately adjacent conductive areas 210 are separated by lengthwise intervals 220. In another embodiment, the patterned transparent electrode layer 200 may have a first axis and a second axis. The conductive area may be arranged according to the first and second axes alignment and separated by a dielectric layer. The dielectric layer can be made of highly transparent, low reflective and low glaring dielectric materials such as polystyrene, PMMA, polyvinyl chloride, polyvinylidene chloride (PVDC), PC, silicone resin, acrylonitrile-styrene (AS), and TPX® (a 4-methylpentene-1 based polyolefin). The dielectric layer can be formed by screen printing, sputtering, lithographing, ink-jet printing or the like. Conventional dielectric layer formation methods well known to those skilled in the art may be employed and the instant disclosure is not limited thereto.

Then the second conductive material is applied to a portion of the circuit area 120 to form the circuit layer 300. The circuit layer 300 electrically couples to the transparent electrode layer 200. The second conductive material exhibits electrical conductance and ductility such as conductive paste, silver paste, and the resin paint containing conductive particles. In the instant embodiment, the second conductive is a non-transparent conductive paste yet the second conductive material may be transparent in another embodiment. Attention is now invited to FIGS. 2A and 2B. The second conductive material coats on the circuit area 120 of the substrate 100 by screen printing, sputtering, lithographing, ink-jet printing or the like to form the circuit layer 300. Conventional coating methods well known to those skilled in the art may be employed to and the instant disclosure is not limited thereto. The circuit layer 300 measures 10 to 10000 nm in thickness. In the instant embodiment, the circuit layer 300 measures 10 to 500 nm in thickness so to permit preferable resistance distribution thereof. The thickness of the circuit layer 300 is not limited thereto.

The circuit layer 300 electrically couples to the transparent electrode layer 200. More specifically, the circuit layer 300 and transparent electrode layer 200 are disposed on the top plane 102. One end of the circuit layer 300 connects the transparent electrode layer 200 and leads there-from. Alternatively, the circuit layer 300 may overlap a portion of the transparent electrode layer 200 and lead there-from. As shown in FIG. 2A, the circuit layer 300 has a plurality of wire areas 310. Each of the wire areas 310 independently leads from individual conductive area 210. Therefore the conductive areas 210 electrically couple to external circuit (not shown) via the wire areas 310. The routing of the circuit layer 300 may vary and one skilled in the art can employ different layouts.

Note that in another embodiment, the formation of the transparent electrode layer 200 and circuit layer 300 may carry out at the same time. That is to say the first and second conductive materials respectively coat the transparent electrode layer 200 and circuit layer 300 simultaneously. For example, a pattern may be printed on the top plane 102 by a printing roller covering a portion of the top plane 102. Then a coating roller is used to coat the first conductive material on the electrode area 110 and the second conductive material on the circuit area 120.

Attention is now invited to FIG. 3. Finally the substrate 100 is shaped to form the deformable or stereoscopic transparent electrode 201. In the instant embodiment, the substrate 100 is thermal formed to bend slightly. As a result, the top plane 102 is concave while the bottom plane 103 is convex. In the meanwhile, the transparent electrode layer 200 on the top plane 102 is also bent to form a mildly curved transparent electrode 201. Similarly, a slightly curved circuit layer 301 is formed in conformity with the curved transparent electrode 201. In the thermoforming process, the substrate 100 accommodates in a mold which has a male die and a female die. The male and female dies are thermal pressed the substrate 100 to form desirable outline in two sides. However the means for shaping the substrate 100 is not limited thereto.

For example, the substrate 100 can be shaped by cold pressing supplemented by vacuum. Specifically, the substrate 100 is positioned in a male die which has a plurality of air vents. The air is drawn out of the mold from the air vents to create a vacuum condition inside the mold. Meanwhile, the substrate 100 fittingly abuts the male die as the air is drawn then being shaped into desired configuration.

Alternatively, the substrate 100 can be shaped only by a portion thereof. For example, the thermoforming can be performed at certain region of the transparent electrode layer 200 to form the stereoscopic transparent electrode 201. On the other hand, the circuit layer 300 of the circuit area 120 remains flat. Furthermore, the stereoscopic transparent electrode 201 may be configured to a great variety of shapes including the combination of curved and planar faces having different orientations and the configuration thereof is not limited thereto.

For different applications, the substrate 100 may be divided into at least two electrodes 201 based on the position of the electrode area 110. The circuit layers 300, 301 are led out from each of the transparent electrode 201 respectively. Specifically, the substrate 100 is valley folded by approximately 90° from the centre of the electrode area 110. The transparent electrode layer 200 on the top plane 102 is also 90° inwardly bent. Moreover, according to the desired shape of the substrate 100, the composition of the first conductive material varies. Thus, the transparent electrode layer 200 is split along the valley fold to form two separate transparent electrodes 201 and the circuit layers 300, 301 are let independently from each of the electrodes 201.

In summary, as shown in FIG. 3, the touch member 1a in accordance with the first embodiment of the instant disclosure includes the substrate 100, deformable or stereoscopic transparent electrode 201 and circuit layers 300, 301. The substrate 100 has the electrode area 110 and circuit area 120 disposed on the surface 101 thereof. The transparent electrode 201 has the electrode layer 200, which is formed on the electrode area 110 and made of transparent conductive material constituted of carbon nanotubes. The circuit layers 300, 301 are formed on the circuit area 120 and electrically couple to the transparent electrode layer 200.

Attention is now invited to FIG. 4 illustrating a top view of a touch member 1b in accordance with a second embodiment of the instant disclosure. The method of manufacturing the touch member 1b is similar to the aforementioned method and the description hereinafter further explains the difference there-between. In the second embodiment, the substrate 100 is the top case of a mouse and the surface 101 has the plurality of electrode areas 110. The touch member 1b further includes a plurality of transparent electrodes 202, 203 and 204 which electrically couples to a sensor circuit 400 via the circuit layer 301. In the second embodiment, the transparent electrode 202 is the left key of the mouse serving as sensing electrode, the transparent electrode 203 is the right key, and the transparent electrode 204 is the roller of the mouse. However, the jobs served by the transparent electrodes 202, 203 and 204 are interchangeable.

According to the embodiment, the touch members 1a, 1b are made of a first conductive material constituted of carbon nanotubes to form the transparent electrode layer 200. The first conductive material is pliable after fabrication so to allow the transparent electrode layer 200 on the electrode area 110 for configuring to deformable or stereoscopic transparent electrode 201 by shaping the substrate 100. Hence the touch members 1a, 1b are flexible and highly applicable to various applications. The method of manufacturing the touch members 1a, 1b includes the formation of the transparent electrode layer 200 on the electrode area 110 of the substrate 100, followed by the formation of the circuit layer 300 on the circuit area 120 of the substrate 100 and finally the shaping of the substrate 100 to configure the deformable or stereoscopic transparent electrode 201. The process is simplified, the yield rate is promoted at the same time and more applications may utilize the touch member.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A method of manufacturing touch member comprising:
providing a substrate including at least one planar electrode area and at least one planar circuit area arranged on the surface thereof;
coating a first conductive material constituted of carbon nanotubes onto a portion of the electrode area for formation of a transparent electrode layer;
coating a second conductive material onto a portion of the circuit area for formation of a circuit layer electrically coupling to the electrode layer; and
shaping the substrate to form at least one deformable or stereoscopic transparent electrode.

2. The method of manufacturing touch member according to claim 1, wherein in the steps of coating the first and second conductive materials further include: simultaneously coating the first and second conductive materials onto portions of the electrode and circuit areas respectively.

3. The method of manufacturing touch member according to claim 1, wherein in the step of coating the first conductive material further includes: screen printing, sputtering, lithographing or ink-jet printing the first conductive material onto the portion of the electrode area.

4. The method of manufacturing touch member according to claim 1, wherein the transparent electrode layer has at least two conductive areas spaced by a predetermined interval or a dielectric layer.

5. The method of manufacturing touch member according to claim 4, wherein the dielectric layer is made of pliable materials.

6. The method of manufacturing touch member according to claim 1, wherein in the step of shaping the substrate further includes: thermoforming the substrate.

7. The method of manufacturing touch member according to claim 1, wherein in the step of shaping the substrate further includes: dividing the electrode area to form at lest two transparent electrodes and lead circuit layer there-from separately.

8. The method of manufacturing touch member according to claim 1, wherein the stereoscopic transparent electrode is curved, planar or the combination thereof.

9. The method of manufacturing touch member according to claim 1, wherein the substrate is visually transparent.

10. A touch member, comprising:
a deformable or stereoscopic substrate including at least one electrode area and at least one circuit area arranged on the surface thereof;
at least one deformable or stereoscopic transparent electrode including a transparent electrode layer disposed on the electrode area and made of transparent conductive material constituted of carbon nanotubes; and
a circuit layer disposed on the circuit area and led from the transparent electrode layer.

11. The touch member according to claim 10, wherein the transparent electrode layer has at least two conductive areas spaced by a predetermined interval or a dielectric layer.

12. The touch member according to claim 11, wherein the dielectric layer is made of pliable materials.

13. The touch member according to claim 10, wherein the substrate is made of thermoplastic materials.

14. The touch member according to claim 10, wherein the substrate is transparent.

15. The touch member according to claim 10, wherein the substrate is a top case of a display device, mouse or joystick.

16. The touch member according to claim 10, wherein the stereoscopic structure is curved, planar or the combination thereof.

17. The touch member according to claim 10, wherein the electrode area is divided to at least two transparent electrodes and the circuit layer is led there-from separately.

18. The touch member according to claim 10 further comprising a sensor circuit electrically coupling to the transparent electrode via the circuit layer.
